(19) United States
(12) Patent Application Publication
(10) Pub. No.: US 2008/0040683 A1
(43) Pub. Date: Feb. 14, 2008

(54) Multi-pane graphical user interface with common scroll control

(76) Inventor: David Walsh, Cambridge, MA (US)

Correspondence Address: ROBERT PLOTKIN, PC, 45 BUTTERNUT CIRCLE, CONCORD, MA, 01742-1937, US

(21) Appl. No.: 11/502,995

(22) Filed: Aug. 11, 2006

(51) Int. Cl. G06F 3/048

(52) U.S. Cl. 715/786; 715/781; 715/784

(57) ABSTRACT

A graphical user interface includes a scrollbar located centrally between two panes displaying interactive content. Moving the scrollbar causes movement of the content in both panes to scroll. The panes include additional content regions (represented, for example, by an image or color) located near the scrollbar. Selecting one of the additional content regions, such as by holding a mouse cursor over it, causes additional content to be displayed. The additional content may include links and an additional scrollbar for scrolling within the additional content.

### BACKGROUND

1. Field of the Invention

The present invention relates to computer-implemented graphical user interfaces and, more particularly, to techniques for reducing the movement required by the user to control graphical user interface elements.

2. Related Art

Early computers used text-based user interfaces, such as command-line interfaces through which the user typed textual commands and the computer provided textual output. Although such interfaces were limited in the amount and quality of information they could display, and required the user to memorize often complex command languages, they remained dominant until the 1980s because they could be implemented using the relatively limited computing power and network bandwidth that was widely available at the time.

Graphical user interfaces (GUIs), which first reached consumers in large numbers with the introduction of the Apple Macintosh in 1984, provide information to users visually in the form of elements such as windows, icons, and menus. Such visual elements have components, sometimes referred to as “controls,” which the user can manipulate using inputs devices such as a keyboard or mouse, to provide input to the computer. Examples of such controls include buttons, scrollbars (also referred to as slider bars), and drop-down lists. Some elements, such as menus and buttons, both provide output and receive input. GUIs became and continue to be popular because they can be used by unsophisticated users with little or no formal training. Although GUIs require significantly more computing power than textual user interfaces to implement, the exponential rate of growth in computing power has made it possible to provide increasingly sophisticated GUIs on low-cost computers.

The rise of networked communications at first brought about a return to older textual user interfaces because of the constraints imposed by available network bandwidth. Early consumer modems, for example, could only communicate over standard telephone lines at 300 Kbs. Only text could feasibly be transmitted in real-time over such connections. Although faster network connections were available, they were priced out of reach of consumers and even most small businesses. As a result, early electronic bulletin board systems provided email and other services that only included textual content.

The advent of the World Wide Web (“the Web”) and the first web browsers began to change this. Although the first incarnation of the Web could only display text, further developments made it possible for web pages to display both text and graphics, including some of the interactive controls (such as checkboxes and drop-down lists) that were familiar to users from desktop software. It also became possible to embed program code (using languages such as Java and JavaScript) within web pages to enable them to perform some of the functions previously only available in desktop software.

Network bandwidth still imposed constraints on the amount of graphic content and program code that could be transmitted to users within web pages. Most consumers continued to access the Internet using modems limited to transferring data at 56 Kbps. As a result, web pages including complex graphics, full-motion video, or significant amounts of program code could not be transferred to users without requiring the users to wait for long periods of time for the pages to load, thereby significantly limiting the interactivity and appeal of such pages. Web page designers, therefore, focused on making their pages as appealing as possible without compromising load times.

More recently, broadband Internet connections have become increasingly affordable and available to consumers through their existing cable, telephone, and satellite providers. As a result, it has become increasingly possible to provide web pages with rich content and functionality without sacrificing interactivity.

Furthermore, the layout and overall visual design of web pages, and the GUIs of web browsers, have not changed appreciably since the early days of the Web. For example, web browsers typically display a web page in a window with a scrollbar on the right-hand side and a menu and toolbar on top. Web pages typically display a list of links across the top and/or left-hand side of the page, with the primary content occupying the remainder of the page. Although such designs struck a reasonable balance in the context of the constraints imposed on web design in the early days of the Web, they do not take maximum advantage of improvements in technology and our increased understanding of the features that contribute to a positive user experience.

What is needed, therefore, are improved techniques for providing users with interactive web pages.

### SUMMARY

A graphical user interface includes a scrollbar located centrally between two panes displaying interactive content. Moving the scrollbar causes movement of the content in both panes to scroll. The panes include additional content regions (represented, for example, by an image or color) located near the scrollbar. Selecting one of the additional content regions, such as by holding a mouse cursor over it, causes additional content to be displayed. The additional content may include links and an additional scrollbar for scrolling within the additional content.

For example, one embodiment of the present invention is directed to a computer-implemented method including: (A) displaying a rendering of content, the rendering including a first pane including a rendering of first pane content and a second pane including a rendering of second pane content; (B) displaying a first movement-control element; (C) receiving input from a user directed to the first movement-control element; and (D) moving the rendering of the first pane content and the rendering of the second pane content in response to the input.

Another embodiment of the present invention is directed to a computer-implemented method including: (A) displaying a rendering of a web page, the rendering including a first frame including a rendering of first frame content and a second frame including a rendering of second frame content, wherein each of the first and second frames is substantially rectangular, and wherein the first frame has dimensions that are substantially the same as dimensions of the second frame; (B) displaying a slider bar between and adjacent to the first and second frames; (C) receiving input from a user directed to the slider bar; and (D) moving the rendering of the first frame content and the rendering of the second frame content in response to the input.

Other features and advantages of various aspects and embodiments of the present invention will become apparent from the following description and from the claims.

### BRIEF DESCRIPTION OF THE DRAWINGS

FIG. 1 is an illustration of the structure of a typical conventional web page within a web browser window;

FIG. 2 is a dataflow diagram of a system for providing improved web page navigation according to one embodiment of the present invention;

FIGS. 3A-3D are illustrations of web pages according to various embodiments of the present invention; and

FIG. 4 is a flowchart of a method performed by the system of FIG. 2 according to one embodiment of the present invention.

### DETAILED DESCRIPTION

Before describing particular embodiments of the present invention, certain desirable features of web browser and web page design and functionality will be described. Symmetry is a desirable element of web page design, and more generally is a predominant design element in everything from cars to architecture to cellphones. Most animals, including humans, have an overwhelmingly symmetrical outer form. Evolutionary psychologists claim that humans have a preference for facial symmetry (and likewise symmetry in general). Symmetry is a feature of certain embodiments of the present invention. For example, certain embodiments of the present invention use a slider bar that is centered within a web page having two columns arranged symmetrically on either side of the slider bar.

Most conventional web sites, however, including those with “tall” web pages (web pages that contain significantly more content than can fit vertically in a web browser window) employ very little symmetry. Instead, “informally balanced” web sites are common, in which several smaller page elements are balanced by one large page element or one darker element is balanced by several lighter elements. A notable exception is Google's homepage, which is nearly symmetrical (even though its search results pages are not). A survey of the most visited web sites on the Internet reveals a landscape of largely asymmetrical, 2- and 3-column sites.

Printed newspapers, for example, eschew symmetry for a layout that gives a visual hierarchy to different elements. Many of the layout principles of web design are derived from the print/publishing world (given its long and successful history). But the web is a different medium/canvas than print, and in its young history the search for the “right shape” for a web page has resulted in an explosion of asymmetrical designs. This is understandable, given that the newspaper industry has had 400 years to find its optimal shape, while the web has existed for fewer than 20 years.

Certain embodiments of the present invention take advantage of the human tendency to gravitate towards symmetry, and to maximize and actualize the usability/likeability potential of symmetry. Furthermore, a web page, unlike a newspaper, is not only viewed (like an art piece) but also used (like a bicycle) by its users. A web page is capable not only of providing users with interactive content, but also of providing users with functionality. The majority of consumer products are symmetrical; the things we use are symmetrical. Web sites are things to use, not paintings hanging on a wall. As a result, web pages stand to benefit significantly from symmetry.

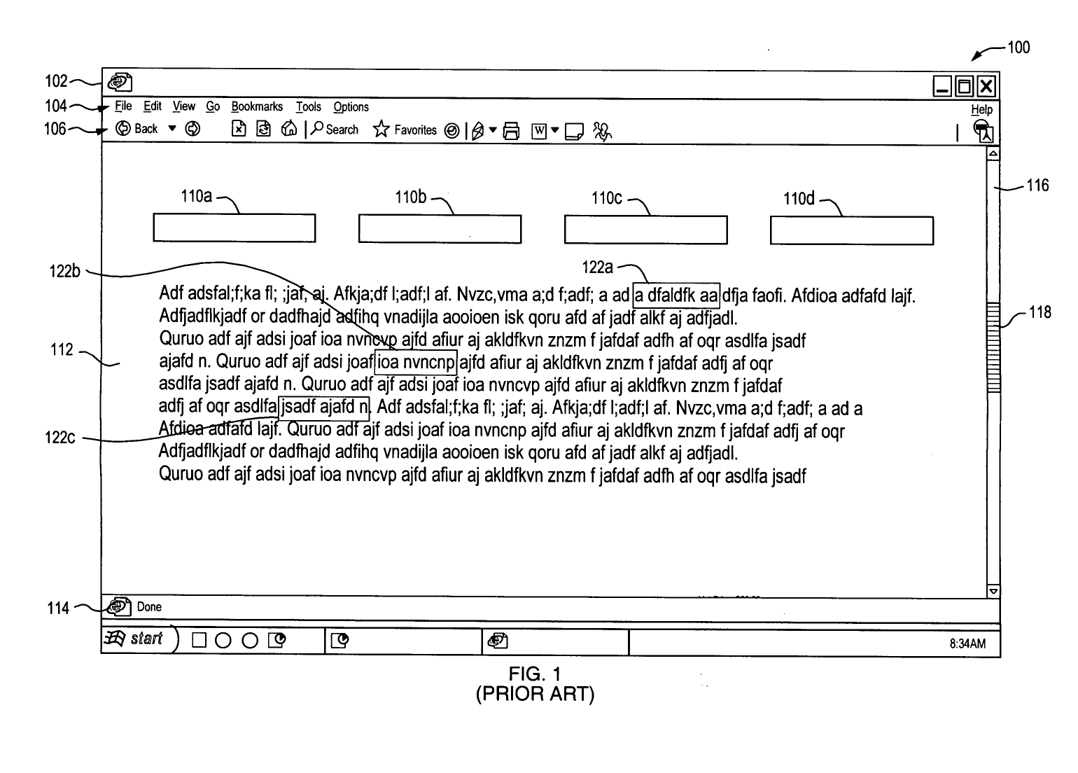

Conventional web sites require users to navigate in a variety of different ways. Generally, navigation consists of clicking on a link that leads to a different web page. For example, referring to FIG. 1, an illustration is shown of the structure of a typical conventional web page shown within a web browser window 100. The web browser window 100 in FIG. 1 is illustrated at an abstract level to indicate features common to many web browsers and web pages, but without specifying any particular web browser or web page.

The window 100 includes a title bar 102 for displaying the title of the web page and/or the name of the web browser; a menu bar 104 for displaying a menu of commands; a toolbar 106 for displaying icons of frequently-used commands; a main content pane 112 for displaying the content of a web page; a status bar 114 for displaying status information (such as whether the web page has finished loading); and a slider bar control 116 for enabling the user to scroll vertically through the web page.

Links can commonly be found along the top of a web site and/or along the left side. For example, the web page displayed in pane 112 includes a set of links 110a-d along the top of the page. Such links typically point to sections of the web site corresponding to different topics and are used for navigating within the web site. One problem with this arrangement is that if the user uses the scroll bar control 116 to scroll down within the web page (by moving the scroll bar “thumb” 118 downward), the links 110a-d may scroll up so far that they are no longer displayed in the window 100. In such a case, if the user wishes to select one of the links 110a-d, the user must scroll back up to the top of the page and select the link. This is tedious and time-consuming.

Even if the links 110a-d were instead placed in a column on the left-hand side of the page, such links could still move outside of the visible portion of the window 100 if the user scrolls down far enough. This is particularly likely to occur when the web page being displayed is a tall web page, such as a blog, an ecommerce site, an auction site, a directory, a newsreader, portal or a search engine.

Furthermore, it is common in conventional web pages for other links to be found within the body of an article or within separate areas positioned elsewhere on the web page. For example, the web page shown in FIG. 1 includes text 120, which includes hypertext links 122a-c. For a real-world example, a site like Forbes.com (typical of large media sites and tall web pages in general) has links throughout the body of its homepage and interior pages.

There are at least two problems with this scattering of links: (1) a user must move the cursor throughout the breadth and height of a web page to select links; and (2) for tall pages, a user must move the cursor over to the right-hand side to use the scrollbar 116, and then back to the body of the page to navigate further. In addition to contributing to repetitive stress disorders (such as carpal tunnel syndrome), such web page designs lead to inefficient navigation that requires a premium of exertion of both the hands and eyes. For example, to locate the scrollbar 116 the user must take his or her eyes off of the content previously being viewed.

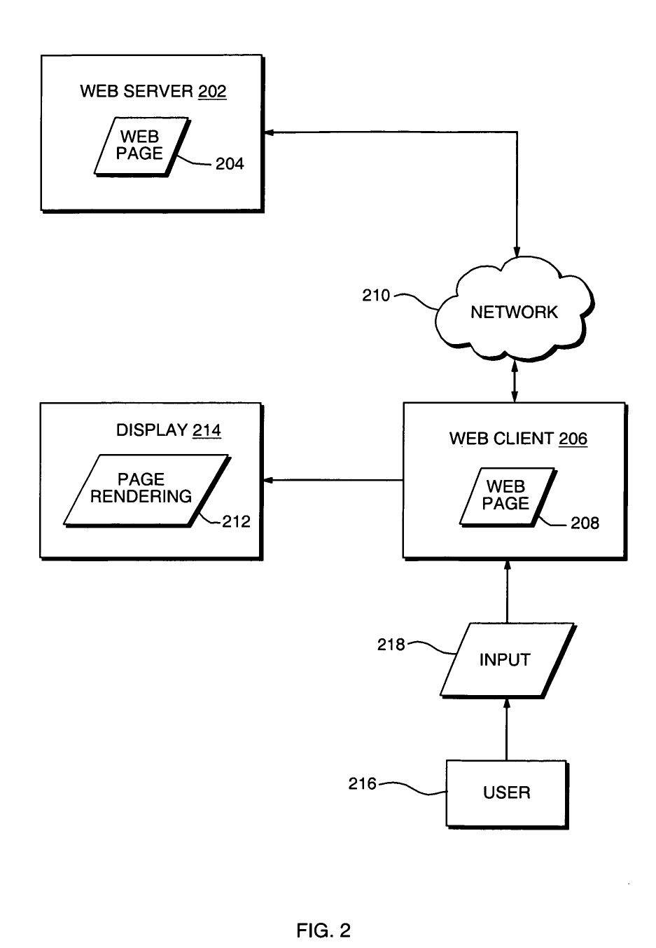

Having described problems with the design and functionality of existing web browsers and web pages, various embodiments of the present invention which address these and other problems will now be described. Referring to FIG. 2, a dataflow diagram is shown of a system 200 for providing improved web page navigation according to one embodiment of the present invention. The system 200 includes a web server 202, which contains a web page 204. As will be described in more detail below, the web page 204 implements various features for improving navigability and overall usability of the page 204.

The system 200 also includes a web client 206, commonly referred to as a web browser. The web browser 206 is connected to the web server 202 over a network 210, such as the public Internet. The web browser 206 may download the web page 204 from the web server 202 over the network 210, store a local copy 208 of the web page 204, and display a rendering 212 of the web page 208 on an output device 214 such as a computer monitor. A user 216 may provide input 218 to the web browser 206 through any kind of input device, such as a keyboard and/or mouse. The web browser 206 may, for example, download and display the web page 208 in response to the user 216 clicking on a link to the web page 208 in another web page (not shown).

The discussion just provided of the operation of the system 200 is well-known to those having ordinary skill in the art. Particular examples will now be provided of the appearance and functionality of web pages implemented in accordance with embodiments of the present invention.

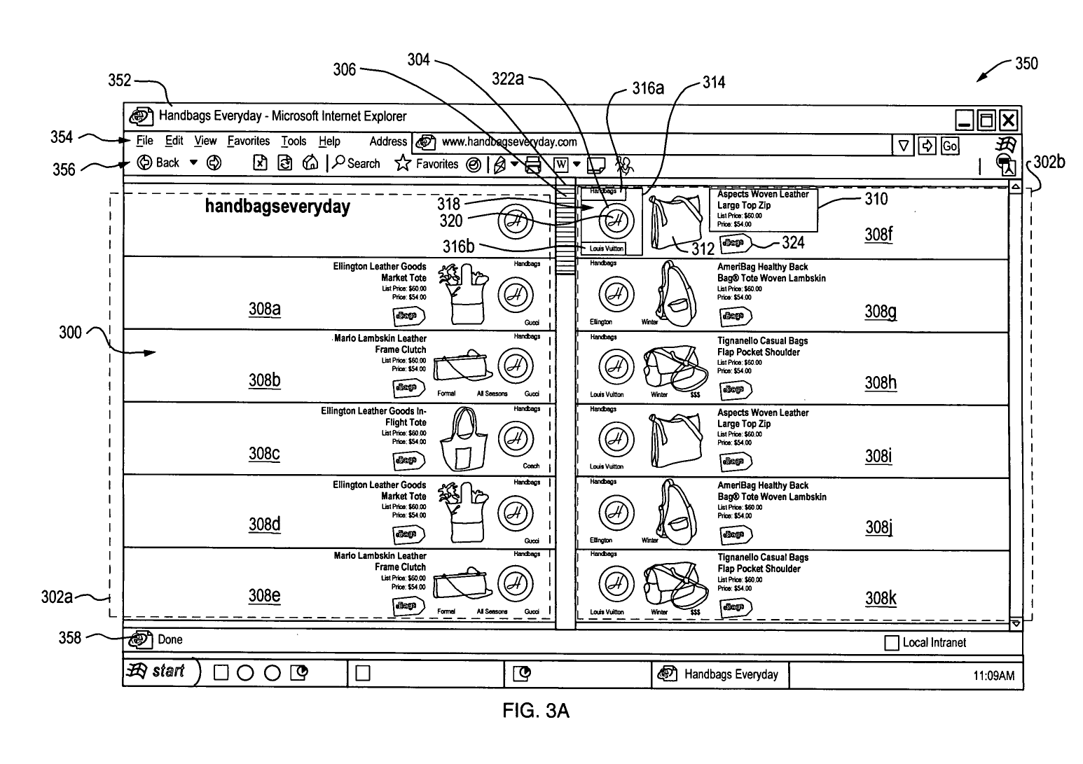

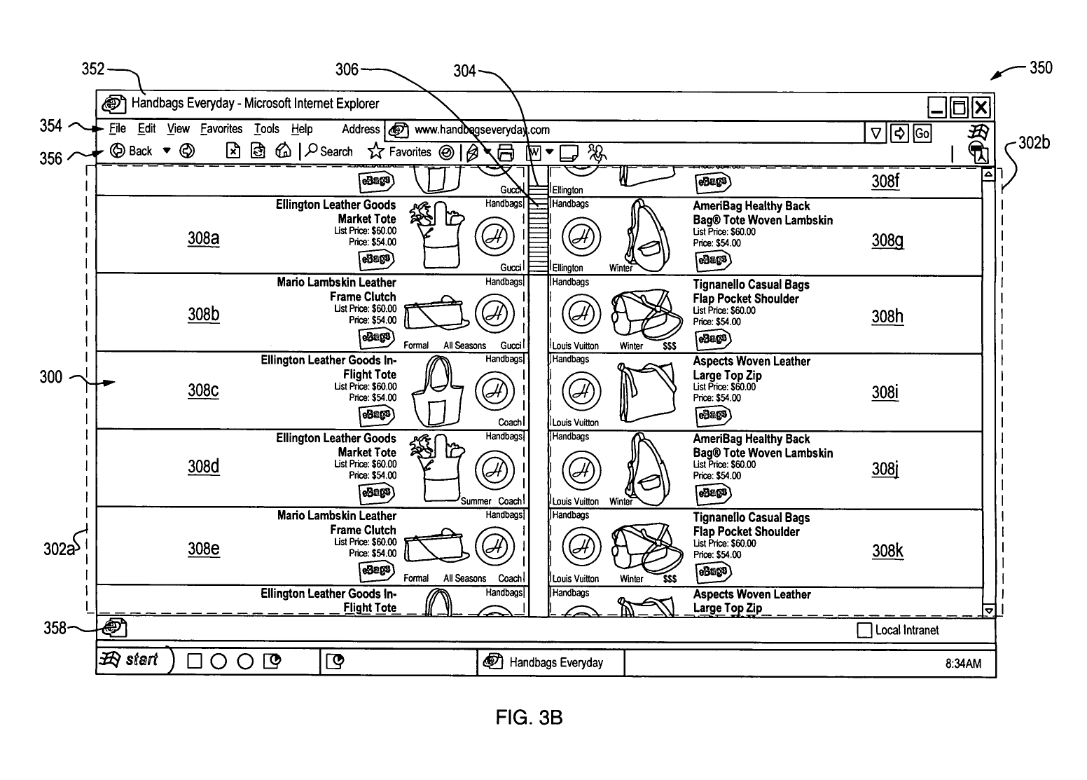

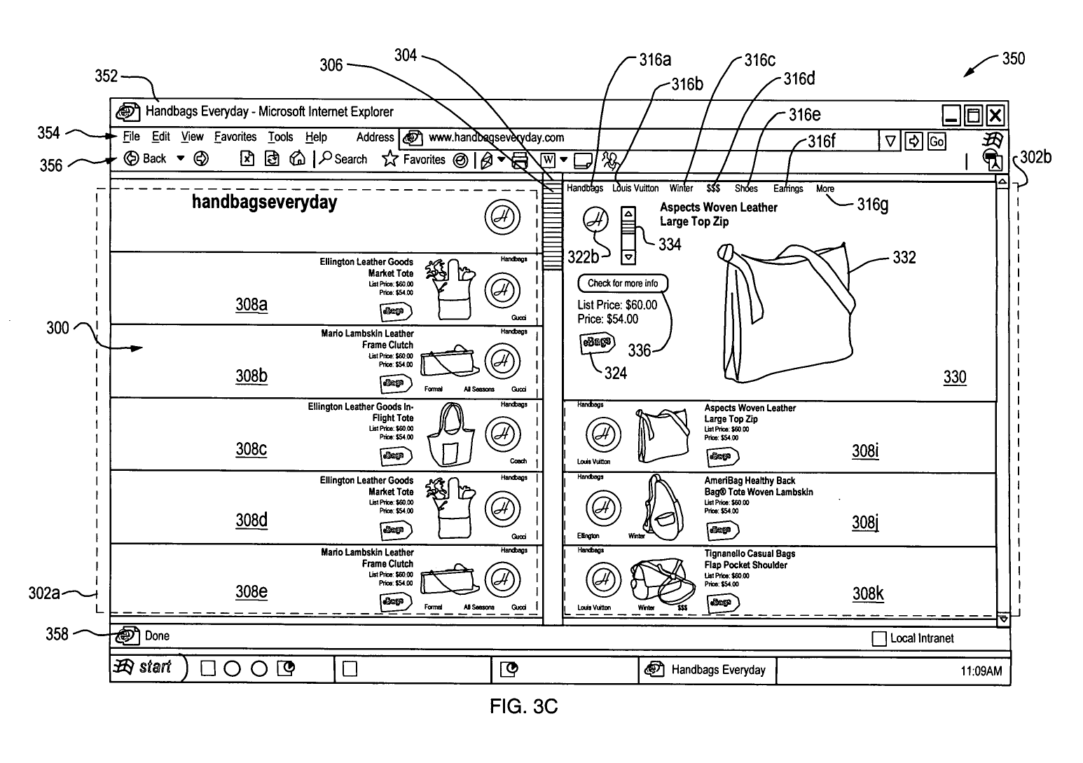

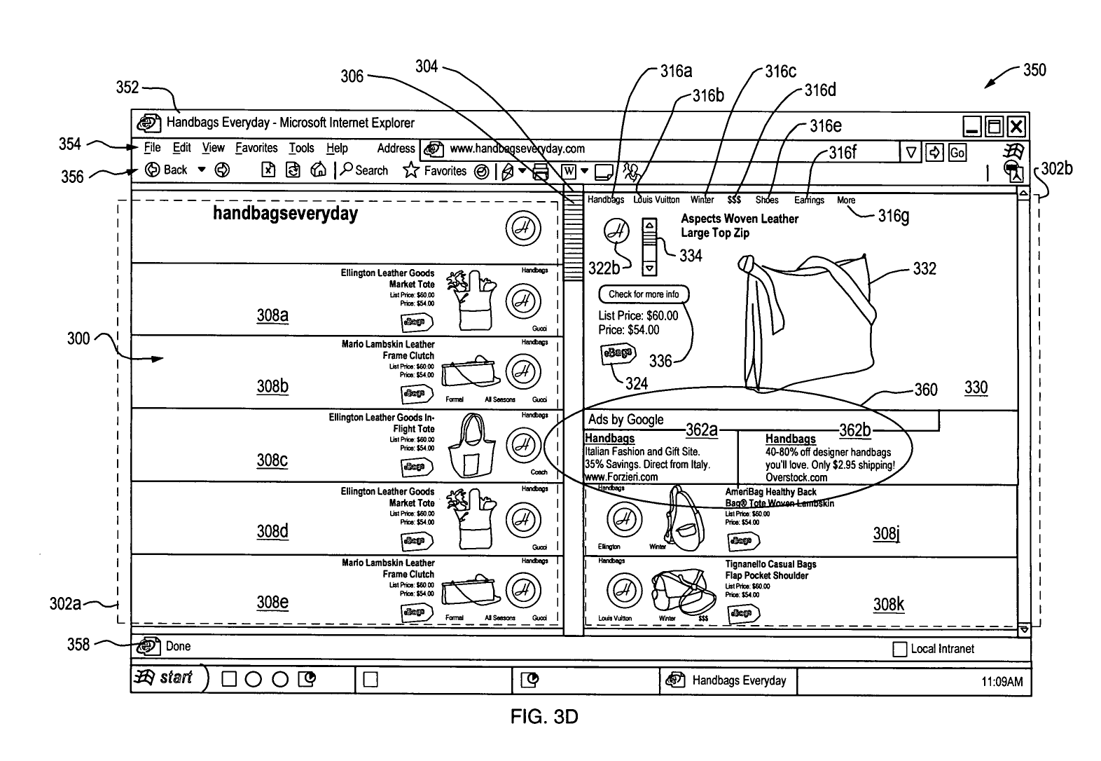

Referring to FIG. 3A, an illustration is provided of a web page 300 designed and rendered according to one embodiment of the present invention. The web page 300 is shown within a web browser window 350, which includes elements such as a title bar 352, menu bar 354, main toolbar 356, and status bar 358. The web page 300 includes two panes 302a and a slider bar 304 located between the panes 302a-b. More specifically, in the embodiment shown in FIG. 3A, the panes 302a-b are of the same shape and size, and the slider bar 304 is located centrally between the panes 302a-b and runs the height of the panes 302a-b.

The user 216 may move the thumb 306 of the slider bar 304 and thereby scroll through the content in both of the panes 302a-b simultaneously. In other words, the slider bar 304 controls movement of the content in both of the panes 302a-b. For example, as shown in FIG. 3B, if the user 216 slides the slider bar thumb 306 downward, the web browser 206 reacts by scrolling the contents in panes 302a-b upward by a corresponding amount, thereby enabling the user 216 to scroll through the content in both panes 302a-b.

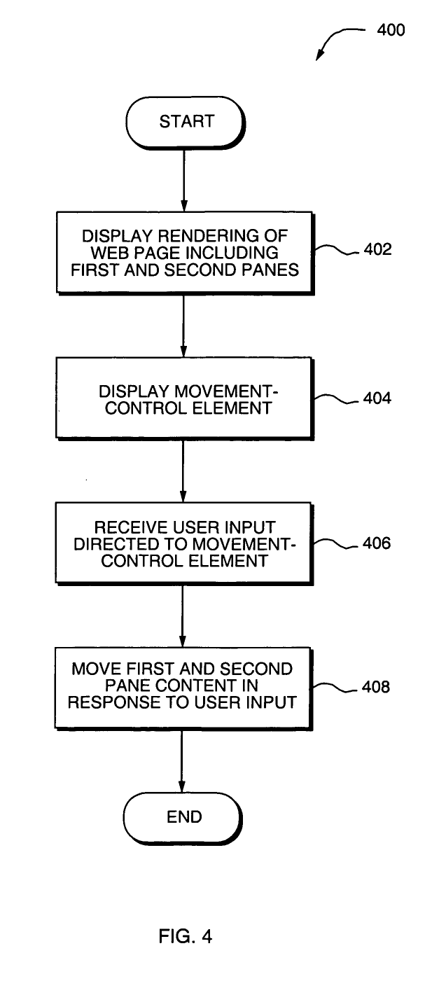

Referring to FIG. 4, a flowchart is shown of a method 400 that may be performed by the system 200 of FIG. 2 to achieve the result shown in FIGS. 3A-3B. The web browser 206 displays the web page 208, thereby producing a page rendering 212, such as the rendered web page 300 shown in FIG. 3A (FIG. 4, step 402). The rendered web page includes first and second panes, each including content. The method 400 displays a movement-control element, such as the slider bar 304 shown in FIG. 3A (step 404).

The method 400 receives input from the user 216 directed to the movement-control element, such as input from the user 216 indicating that the slider bar 304 should be moved up or down (step 406). In response to the user input, the method moves the content in the first and second panes (step 408). For example, in response to the user 216 dragging the slider bar 304 downward, the web browser 206 may move the content in the panes 302a-b upward, or vice versa.

The use of a slider bar that is located between two panes and that controls scrolling through the contents of both panes simultaneously has numerous advantages. For example, by placing the slider bar 304 between the two panes 302a-b, rather than on one side of the window 300 (as in the case of the window 100 shown in FIG. 1), the amount of movement required by the user 216 is reduced. On average, the user 216 will need to move the mouse cursor a shorter distance to reach the scrollbar 304 than to reach a scrollbar located at the far right-hand side of a window. This is particularly true when, as described below, critical content of the page web is located close to and on either side of the scrollbar 304. Reduction of mouse movement makes the user's web browsing experience more efficient, reduces the likelihood that the user 216 will experience a repetitive stress injury, and may reduce wear and tear on the mouse.

In the particular embodiment shown in FIG. 3A, the scrollbar 304 is located not only between the two panes 302a-b but also centrally between the two panes. As shown in FIG. 3A, the scrollbar 304 divides the window into two equally-wide halves. This produces a kind of symmetry that is not only visually appealing but also conducive to efficient web browsing and web design (of certain types of web sites). For example, making both of the panes 302a-b the same size facilitates populating the web page 300 with content. Consider, for example, the e-commerce web site shown in FIG. 3A, which contains long lists of elements. Making both of the panes 302a-b the same size facilitates placing any element in the list in either of the panes 302a-b. If the panes 302a-b differed in size from each other, content would either need to be designed differently for the different panes (thereby complicating the web design process), or might appear differently in different panes (thereby reducing the ease of understanding and navigability of the web page). This feature is particularly beneficial for use with e-commerce sites, portals, and other web sites which dynamically pull in and display content from other sources, because the standard sizing and layout of the web page 300 provides a standard interface through which such content may be imported and presented automatically and with a predictable appearance.

Note that providing the scrollbar 304 at a central location between the two panes 302a-b is not a requirement of the present invention. Similarly, making the two panes 302a-b be of equal shapes and/or sizes is not a requirement of the present invention.

Furthermore, note that the slider bar 304 may be controlled by input devices other than a mouse. For example, the slider bar 304 may be controllable by a keyboard (e.g., the up and down arrow keys). Even when a keyboard is used instead of or in addition to a mouse to control the slider bar 304, the web page design illustrated in FIG. 3A retains many of its benefits. For example, the web page 300 remains easy to design, understand, and navigate because the centering aspect of the design congregates the most salient bits of information of both columns towards the center of the web page. Most shopping sites have only one column of listings, which in itself is less efficient than the designs disclosed herein. Even two-column sites, such as Google News, force the users' eyes to range between the far left and just right of center in their search for salient/identification bits, such as the title of the listing or the picture associated with the listing).

The web page 300 shown in FIG. 3A also has the benefit of being capable of implementation in a standard web browser, without requiring modifications to the web browser's source code. For example, the code for rendering each of the panes 302a-b may include standard code for rendering a web browser frame, and the code for rendering the slider bar 304 may include standard code for rendering a web browser slider bar. Such code may include, for example, code written in HTML, Java, JavaScript, VBScript, or any other suitable language or combination of languages. One benefit of making the web page 300 implementable in a standard web browser is that users need not obtain a customized web browser or other special-purpose application to access the web page 300. Note, however, that it is not a requirement of the present invention that the techniques disclosed herein be implemented in a standard web browser or in a web browser at all.

Before explaining additional features and benefits of the example web page 300 illustrated in FIG. 3A, the example content of the web page 300 will first be described. Merely for purposes of example, the web page 300 in FIG. 3A is an example of a web page in an ecommerce web site. The web page 300 displays a list of goods for sale, namely handbags. Although only eleven elements 308a-k are shown in FIG. 3A, the web page 300 includes additional elements located “below” the visible elements 308a-k, but which do not fit within the web browser window 300. If the user 216 were to move the thumb 306 downward, the additional elements would scroll into view, as shown in part in FIG. 3B. The web page 300 is an example of a “tall” web page as that term is used herein.

Each of the elements 308a-k contains product information for a particular handbag. For purposes of example, the contents of element 308f will now be described in more detail. The remaining elements 308a-e and 308g-k contain similar contents and function in the same manner. In the embodiment shown in FIG. 3A, the only difference between the layouts of elements 308a-e and the layouts of elements 308g-k is that the content in elements 308a-e is right-justified, while the content in elements 308g-k is left-justified.

Element 308f includes a product description region 310 providing summary information about the handbag represented by element 308f, such as its name and price. Element 308f also includes a thumbnail graphic image 312 of the handbag, and an icon 324 representing a logo of a retailer from which the corresponding product may be purchased. The icon 324 may act as a link, in which case when the user 216 clicks on the icon 324, the web browser 206 may navigate to the linked-to web site. In other words, if the user 216 wishes to purchase the product illustrated in element 308f, the user 216 may click on the icon 324 and then purchase the product from the resulting web site. The listing title itself (shown as bold text within element 310) may also be a link with the functionality described above for icon 324.

Furthermore, element 308f includes an “additional content region” 314. The additional content region 314 contents visual elements which may be selected by the user to display additional content related to the product represented by element 308f. The additional content region 314 may, for example, include links to content elsewhere on the same web page, on other web pages on the same web site, or on external sources (e.g., other web sites). The additional content region 314 may additionally or alternatively include, for example, a rollover zone which the user 216 may rollover to access additional content. These and other features of the additional content region 314 will be described in more detail below.

For example, the example additional content region 314 shown in FIG. 3A includes a primary category link 316a and a secondary category link 316b. In the example shown in FIG. 3A, the primary category link 316a reads “Handbags,” indicating that the product displayed in element 308f is a handbag. Note that all of the elements 308a-k on the web page 300 have a primary category of “Handbags” because all of the corresponding products are handbags.

In the example shown in FIG. 3A, the secondary category link 316a for element 308f reads “Ellington,” indicating that the product displayed in element 308f is an Ellington handbag. Note that the secondary categories of the elements 308a-k shown in FIG. 3A vary. For example, the secondary category of element 308a is “Gucci,” while the secondary category of element 308d is “Coach.”

Although only one secondary category link is shown for element 308f in FIG. 3A, this is not a limitation of the present invention. For example, as shown in FIG. 3A, listing 308d includes two secondary category links and element 308b includes three secondary category links. More generally, elements may include any number of primary and secondary category links.

The user 216 may click on, or otherwise select, the primary category link 316a or the secondary category link 316b. If the user 216 selects the primary category link 316a (“Handbags”), the web browser 206 may display a new web page displaying only products of the selected primary category. Similarly, if the user 216 selects the secondary category link 316b (“Ellington”), the web browser 206 may display a new web page displaying only products of the selected secondary category.

Note that in the example illustrated in FIG. 3A, the additional content region 314 in general and the primary and secondary category links 316a-b in particular are placed in close proximity to the scrollbar 304. As a result, if the user 216 uses the scrollbar 304 to scroll through the web page 300 and sees a primary or secondary category in which he is interested, he may move the mouse cursor to the corresponding link (e.g., link 316a or 316b) using a minimum of mouse movement. This represents a significant navigability and overall usability improvement over conventional web page designs, in which the scrollbar is located to one side of the web page and the links are located on the top of the web page, thereby requiring the user to move the mouse large distances to select links of interest.

When content and navigation are blended together within a structure (as in the embodiment illustrated in FIG. 3A), the notion and necessity of navigation fades into the background. The location of the cursor, the user's visual focus, the content, and the next step (e.g., a link to other content) converge. The cursor and the user's visual focus, by design, gravitate about the center spine of the browser window. As a result, the user no longer needs to scroll back to the top of the page to identify his current location in the web site and to identify other content to which the user may browse.

In the embodiment shown in FIG. 3, all of the elements 308a-k are the same size and share the same general layout. Just as making both of the panes 302a-b the size is conducive to efficient web browsing and design, making all of the elements 308a-k the same size and/or share the same layout is beneficial because such a standardized listing size/layout creates and satisfies a comfortable expectation by the user. The user may visit any web site that uses the techniques disclosed herein with the expectation that listings on such web sites will conform to a standardized listing size and/or layout. Once the user, after a short period of time, has become accustomed to the standardized size and/or layout, the user may navigate through such listings with minimal effort and with a high degree of comfort.

Standardized listing sizes and layouts are not, however, a requirement of the present invention. For example, one or more listings on a particular web page may be pre-opened or partially opened to display some or all of the corresponding additional content, and/or to provide added emphasis or for other reasons. Furthermore, deviating from an otherwise standard size/layout may have salient visual impact without detracting from otherwise standardized sizes/layouts. In fact, creating and maintaining standards to enforce stable user expectations, and then deviating from those standards only in exceptional cases may both reinforce the standards and emphasize the exceptional case from the user's perspective.

The additional content region 314 further includes a product detail region 318. The user 216 may select the product detail region 318 to obtain additional details about the product represented by element 308f. In the particular example illustrated in FIG. 3A, the product detail region 318 is a graphic image consisting of a small circle 320 (which may, for example, display the web site's logo, the logo of the vendor, or a category-specific icon) within a larger circle 322. Note, however, that the product detail region 318 may take any form.

The user 216 may select the product detail region 318 in any way, such as by clicking on it or by holding the mouse cursor over it. The latter is typically referred to as a “mouseover.” The following description will assume for purposes of example that the product detail region 318 is selected (activated) using a mouseover.

FIG. 3C is an illustration of the web page 300 as it appears when the user 216 holds the mouse cursor over the product detail region 318 according to one embodiment of the present invention. In particular, in response to the user 216 holding the mouse cursor over the product detail region 318, the web browser 206 displays product detail content 330 containing a larger image 332 of the product illustrated in the element 308f of FIG. 3A. This provides the user 216 with more detail with which to evaluate the product.

Note that in the embodiment shown in FIG. 3C, the product detail content 330 is displayed in a popup box over the web page 300. For example, note that the product detail content 330 temporarily obscures elements 308g and 308h, which were visible in FIG. 3A. The term “popup box” refers herein to a graphical user interface element for displaying content, but which does not contain all of the elements of a window, such as a title bar, menu bar, or close box. Popup boxes are typically used to display a relatively small amount of information temporarily and with a minimum of distraction from the task the user was engaged in before the popup box was displayed. Popup boxes used in conjunction with embodiments of the present invention, however, need not be temporary or fixed in size. For example, popup boxes may be displayed and left open until manually closed by the user. Furthermore, popup boxes may be resizable either by the user or automatically by the web browser (e.g., to accommodate the size of the content displayed within the popup box). Moreover, popup boxes may be detached or detachable from the main content window.

The benefit of displaying the product detail content 330 in this way is that it does not require the web browser 206 to load a new window or for the user's browsing experience to be otherwise disrupted. For example, the user 216 may continue to view the product summaries in the remaining visible elements 308a-e and 308g-k while viewing the new product detail content 330.

In the embodiment illustrated in FIG. 3, a standard popup box size is used, thereby creating and satisfying settled user expectations. Standard popup sizes may be particularly beneficial when, for example, the techniques disclosed herein are used to deploy a portal which mixes different kinds of content from different sources (e.g., news stories, videos, product listings). Using standard popup box sizes across such multiple sources and kinds of content makes it easier for the user to absorb and navigate such content and thereby makes the user's browsing experience more efficient.

Note further that in the embodiment shown in FIG. 3C, the popup box 330 “fits in” with the remaining elements 308a-e and 308i-k. More specifically, the width of the popup box 330 is the same as the width of the elements 308i-k in the same column 302b, and the height of the popup box 330 is an integer multiple (e.g., 3) of the height of an individual element. This feature of the design further reduces the disruption to the user's visual experience caused when the popup box 330 is displayed.

Although a “popup box” 330 is used to display the additional content in FIG. 3C, this is not a limitation of the present invention. Rather, other graphical user interface elements, such as windows or browser frames may be used to display the additional content.

Furthermore, the content displayed in the product detail content 330 may have been pre-downloaded and cached locally by the web browser 206. For example, when the user first moves the mouse cursor over an element (such as element 308f), the corresponding additional content (e.g., the product detail content 330 shown in FIG. 3C) may be pre-downloaded and cached in anticipation of the user selecting the additional content region 318. As a result, the web browser 206 may display the product detail content 330 essentially instantaneously in response to the user's selection (e.g., mouseover) of the product detail link 314, without the need to access the network 210. This greatly improves the interactivity and therefore usefulness of the user's browsing experience. Furthermore, the entire web page 300 (including those elements not visible in FIG. 3A) may be downloaded and cached, and then viewed offline (i.e., without a connection to the network 210, or while the connection to the network 210 has been temporarily lost).

As another alternative, technologies such as AJAX and/or SOAP may be used to increase the responsiveness of the web page 300 to user input. Such technologies, which leverage XML, may be used to make the web page 300 more responsive by exchanging relatively small amounts of data with the server 202 behind the scenes in response to user input, rather than reloading the entire web page 300 in response to each user action. This feature can be used to make the web page 300 respond more like a traditional software application than a traditional web page. AJAX and SOAP are merely examples of classes of technologies that may be used for this purpose, and do not constitute limitations of the present invention.

When the product detail content 330 is displayed, the web browser 206 may further display a scrollbar 334 within the content 330. In the example shown in FIG. 3C, the scrollbar 334 is a small scrollbar (smaller in both width and height than the scrollbar 304) displayed within the area of the product link 314. The web browser 206 moves the content (e.g., image 332) of the product detail content 330 in response to movement by the user 216 of the thumb of the scrollbar. This feature enables the product detail content 330 to display content that does not fit within the content 330, while allowing the user 216 to view such content in its entirety. This feature is particularly useful because the it allows the user 216 to view a large amount of content using a screen element (the popup box which displays the product detail region content 330) that is relatively small, that does not obscure a significant portion of the web page 300, and that potentially does not require a network access.

The product detail content 330 may include links. For example, the icon 324 still appears in the product detail content 330. This is beneficial because although the user 216 may not initially decide to purchase the product upon viewing the limited information displayed in the element 308f (FIG. 3A), the user 216 may decide to purchase the product upon viewing the more detailed information displayed in the product detail content 330. Providing the icon 324 (which may link to a site from which the product may be purchased) directly in the product detail content 330 enables the user 216 to begin the purchasing process as quickly and using as few clicks as possible. Other elements within the listing 308f and/or the product detail content 330 (such as the listing title (within element 310), the images 312 and 332, and the “Click for more info” button 336) may provide the same functionality as that just described for the icon 324.

In the embodiment shown in FIG. 3C, the popup box 330 continues to display the primary category link 316a, as part of a row of links 316a-g along the top of the popup box 330. This row of links provides the user 216 with easy access to links to content that are relevant to the content displayed in the popup box 330, in order of decreasing likelihood to be of interest to the user 216. For example, the next link after the primary category link 316a is the secondary category link 316b (copied or moved from its position in FIGS. 3A-3B). This is followed by additional links 316c-d to categories of products (“Winter” and “$$$”) under which the displayed product is categorized. The next two links 316e and 316f (“Shoes” and “Earrings”) are links to categories related to the category of the product on display, which the user 216 might find of interest. Finally, a “More” link 316g enables the user 216 to view a more complete list of links to other content.

The particular list of links 316a-g shown in FIG. 3C is merely an example and does not constitute a limitation of the present invention. Such links may be selected and organized in any manner. Whatever particular form the links take, they provide the user 216 with the ability to navigate to relevant content directly from the popup box 330, without disrupting the user's navigational flow. To browse from the popup box 330 to the secondary category, for example, the user 216 need not first close the popup box 330 and then select the secondary category link 316b from the main web page 300. Instead, because the secondary category link 316b has been moved into the popup box 330 itself, the user 216 may select the secondary category link 316b directly from the popup box 330. The same is true of the other links 316c-g in the popup box 330, even if such links were not present in the main web page 300 before the popup box 330 was displayed. This use of links within the popup box 330 is another way in which embodiments of the present invention provide links near the user's visual focus and thereby both reduce the amount of mouse and eye movement required to find and select links and reduce the number of steps required for the user 216 to navigate through hyperlinked content.

The product detail region 318 may further link to other content. For example, on mouseover of the region 318 the popup box 330 may be displayed, while a mouse click of the region 318 may activate a link to the same target as the icon 324 and images 312 and 332 (such as the retailer of the displayed product).

Furthermore, in response to the user 216 selecting the product detail region 318, the web browser 206 may change the color of the outer circle 322a to a “visited link” color to indicate that the product detail region 318 has been selected. This may occur immediately or, for example, after the user has viewed the additional content for longer than a predetermined minimum period of time (e.g., 5 seconds). The “visited link” color may vary depending on the amount of time the user has spent viewing the additional content. For example, if the user views the additional content for longer than the predetermined time period, the outer circle 322a may change to a brighter color, while the outer circle 322 may change to a dimmer color if the user views the additional content for less than the predetermined time period.

As shown in FIG. 3C, the diameter of the larger circle 322a may be decreased to a smaller version 322b to provide a visual indication that the product detail region 318 is active (currently selected). When the user deselects the product detail region 318 (such as by moving the mouse cursor outside of the product detail region 318), the web browser 216 may again display the outer circle at its original size (as shown by circle 322a in FIG. 3A), and remove the product detail content 330, thereby again revealing the elements 308f and 308g (as shown in FIG. 3A).

Even after the user 216 has deselected the product detail region 318, the web browser 206 may continue to display the inner circle 320 using the “visited link” color to indicate that the user 216 has selected the product detail region 218 previously. This provides a useful visual cue to the user 216, whereby the user 216 may visually scan the web page 300 and quickly identify products for which he has already viewed more detailed information. This enables the user 216 to browse the page 300 more efficiently.

The techniques disclosed herein may be used in conjunction with an advertising model (e.g., deploying banner ads and Google Adwords) that is built around “focused page views” as opposed to the traditional “page view” model. Presently (and generally), multiple banner ads are deployed throughout a web page, often at the top above all content, along the sides, and also within the body of articles. One of the key metrics for banner ads (and the way in which they are usually sold) is the number of page views that a banner receives.

The techniques disclosed herein improve on this concept by providing an interface architecture that only displays an ad when the user is interacting with content. For example, one or more ads may be displayed as a part of the popup that results from a mouseover on the product detail region 318, as shown in FIG. 3D. As shown therein, an advertisement region 360 is displayed in addition to the product detail content 330. In the particular example shown in FIG. 3D, the advertisement region 360 includes two advertisements 362a-b for handbags. An advertisement server may select the advertisements 362a-b based on the product detail content 330, thereby ensuring that the advertisements 362a-b are relevant to the content 330. Because the advertisements 360 are displayed next to the product detail content 330 and only when the user 216 initiates the display of the product detail content 330, advertisers may be assured that the eyeballs they are seeking are literally only an inch or two away from their advertisements.

Note that the particular form and content of the advertising region 360 shown in FIG. 3D is merely an example and does not constitute a limitation of the present invention. Advertisements may be selected, formatted, and displayed in ways other than that shown in FIG. 3D. For example, banner ads for products of a sports-related company (e.g., Nike) could be displayed repeatedly on a sports shopping site.

Furthermore, the techniques disclosed above may be used to implement an advertisement in the same way as one of the product listing elements 308a-k shown in FIG. 3. Such an advertisement may, for example, include an additional content region having the content and functionality described above with respect to the product elements 308a-k. For example, if the user performs a mouseover on the additional content region of the advertisement, additional relevant advertising content may be displayed in a popup box. Such an embodiment extends the standardization of the user's browsing experience from non-advertising content to advertising content. This embodiment takes advantage of the increasingly blurring line between content and advertisements and the increasing frequency of user-initiated interaction with advertisements to provide a browsing experience that integrates content browsing with advertisement browsing.

The techniques disclosed herein have a variety of advantages. In general, for example, various techniques disclosed herein improve the ergonomics of navigating a tall web page, making the browsing/reading/shopping experience more physically comfortable, but also more efficient by reducing the amount of time and physical movement needed to perform the same functions. Efficiency gains may be realized by both the end user (who avoids wasting time finding the content he or she is looking for) and the site owner (who stands to benefit/profit because users spend less time trying to find content relative to the time they spend looking at content and making purchases).

Ergonomic improvements, such as reducing the amount of physical movement required to navigate web pages, can have a variety of secondary effects. For example, as the population ages worldwide and more elderly people use the Internet, improved ergonomics may not only make web browsing more efficient but also make it possible for people to browse the web for longer periods of time. The same conclusion applies more generally to people with physical disabilities which limit their manual dexterity and/or stamina. Sites that cater to such groups will be able to provide their users with not just a more enjoyable experience, but also a more viable experience. Even for people without current physical disabilities, improving ergonomics generally, and reducing mouse movement in particular, may reduce the incidence of repetitive stress disorders and muscle fatigue.

As described above, embodiments of the present invention may display content and perform other functions in response to “mouseover” events. Although some existing web sites use mouseovers to provide the user with additional information about content displayed on the web site, embodiments of the present invention take this a step further. For example, embodiments of the present invention employ mouseovers as the primary first step for obtaining more information. Presently, clicking on a link typically is the primary first step for obtaining more information on a web site, even when the web site has mouseover elements.

Furthermore, in embodiments of the present invention, the resulting popup box (e.g., the product detail popup box 330) is navigable using, for example, the scrollbar 334. Moreover, the web page may provide a color cue to denote that a mouseover zone has previously been moused-over.

Furthermore, the techniques disclosed herein may be used to provide the site owner with real-time knowledge of where a user is presently looking, to a high degree of certainty. Such knowledge has high commercial value, because it can be used to determine which regions of a web page attract the most user attention, and which paths lead to “buy” and “no buy” decisions by the user. Inferences about the location of the user's attention may be drawn because there is only one cursor to work with, and only one mouseover zone can be activated at a given time. As a result, when a mouseover zone is activated, it can be inferred with a high degree of certainty that the user's gaze is focused on the mouseover zone at that time. Such measurements can be used for purposes of attracting advertisers to advertise on the web page, and for providing differential pricing for different regions of the web page based on which regions receive the most attention, analogous to the way in which supermarkets price eye-level shelf space more highly than ground-level shelf space.

The techniques disclosed herein are particularly appropriate for use with tall web pages. For example, shopping sites, auction sites, directories, search engines, blogs, newsreaders, and portals stand to obtain particular benefits. Ecommerce sites, such as shopping sites and auction sites, may benefit from the inherent efficiencies that the techniques disclosed herein provide. More efficient browsing means less time searching and more buying; this may translate directly to improved revenue. For example, if a shopping site is easier and faster to use, the results for the owner are two-fold: (1) some users will find what they are shopping for more quickly (which makes for a happier customer who will be more inclined to return); and (2) some users may use the extra time to make more purchases.

As a result, the techniques disclosed herein make presenting a tall page of information a more attractive and viable option. Presently, tall web pages are often truncated and/or divided into separate pages or other parts. For example, search results pages often display a subset of the search results, with text such as “Displaying Results 1-20” and “Click for results 20-40” at the bottom of the page. In contrast, embodiments of the present invention present the user with a visual overview of the available landscape of wares, much like a physical department store. Existing web site designs are more closely analogous to a department store floor broken up into small rooms, none visible from the other.

In addition to providing web sites that are more inviting to the user generally, the techniques disclosed herein are able to present more information than conventional web sites, including information about related items that the user may not specifically be looking for. As a result, the techniques disclosed herein may empower suggestive selling.

Advertiser-driven sites, such as directories, search engines, blogs, and portals benefit similarly from the improved efficiencies and likeability described herein with the added benefit of the “focused page view” advertising model. As described above, this model provides advertisers with an assurance that the user's attention is focused on the advertiser's advertisements when those advertisements are displayed. This is a significant improvement over the current model, in which the fact that an advertisement is displayed provides no assurance that the user is viewing the advertisement. Furthermore, because the length of time that a popup window is displayed can be monitored automatically and provided back to the server 202, the focused page view model enables collection of accurate information about the amount of time the user views particular advertisements. Such information can be used not only to drive more advertisers to a successful web site, but also to increase ad revenue based on a model in which revenue is tied to viewing duration.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although certain examples provided herein employ symmetrical content, this is not a requirement of the present invention. For example, the pane 302a shown in FIG. 3A may be wider than the pane 302b, making the web page 300 asymmetrical. Furthermore, although the content within the panes 302a-b shown in FIG. 3A is symmetrical, this is not required.

Furthermore, although certain examples provided herein involve ecommerce web sites, this is not a limitation of the present invention. Rather, the techniques disclosed herein may be applied to any kind of content, which need not be related to commerce.

Although reference is made herein to “tall” web pages, the present invention is not limited to such web pages. For example, the techniques disclosed herein may be applied even to pages that fit fully within a single web browser window, thereby reducing the amount of mouse movement necessary to navigate within that page. Furthermore, although the scrollbar 304 shown in FIG. 3A scrolls vertically (up and down), this is not required. The scrollbar 304 may, for example, split the web page vertically, in which case the panes 302a-b would be above and below the (horizontally-oriented) scrollbar 304. As a result, moving the scrollbar 304 left and right would cause content within the panes 302a-b to move right and left, respectively. As yet another alternative, two scrollbars may be provided side-by-side, each of which may independently control one of the two panes 302a-b.

Although certain examples provided herein are described with reference to web pages displayed by a web browser, the present invention is not limited to use in conjunction with web pages and/or web browsers. For example, the elements of the web page 300 shown in FIG. 3A may alternatively be applied to the graphical user interface of a software program other than a web browser. Such a graphical user interface may be useful for enabling the user of such a program to easily navigate through content displayed by the program. The content need not even include hyperlinks, and the program need not access content over a network. For example, the graphical user interface may be used to browse within an encyclopedia stored wholly on a local hard disk drive or DVD.

Similarly, the panes 302a-b need not be implemented as frames in a web browser window. Rather, the panes 302a-b may be implemented as any regions for displaying content. They may be of any shape and size in any combination. Furthermore, there may be more than two panes. In addition, although the panes 302a-b shown in FIG. 3A do not touch each other, this is not required.

The scrollbar 304 shown in FIG. 3A is merely one example of a movement-control element. The scrollbar 304 may, for example, supplement rather than replace the typical right-hand side scrollbar in a web browser window. The scrollbar 304 may be controlled with any kind of input device, such as a keyboard or mouse (e.g., movement or scroll wheel). The color and/or hue of the scrollbar 304 may change upon a mouse click and/or mouseover on the scrollbar 304.

The scrollbar 304 may be implemented to provide the functionality of a “shuttle” and/or a “jogger” typically used in video editing, in which video footage is typically represented on a horizontal axis. A shuttle is a graphical user interface element (or a physical component) that may be moved to the right or left to control both the direction of video playback (where moving the shuttle to the right causes the video to play forward and moving the shuttle to the left causes the video to play in reverse) and its speed (where moving the shuttle further to the right/left causes the video to play back more quickly). A jogger is a graphical user interface element (or a physical component) which is manipulated to move the current playback position in increments of individual frames. The scrollbars disclosed herein may be combined with shuttles/joggers in various ways to obtain the benefits of both.

Furthermore, embodiments of the present invention are consistent with web page designs in which there is no scrollbar between panes. For example, referring again to FIG. 3A, if the number of listings on the web page 300 is small enough to fit within the window 350, then the scrollbar 304 need not be displayed. In such a case, the scrollbar 304 may be eliminated from the page 300 and a conventional scrollbar displayed (e.g., on the right side of the page 300) instead. If the number of listings increases such that they cannot all be displayed in the window at the same time, the central scrollbar 304 may be added to the page 300 and the side scrollbar removed.

Although the additional content region 314 and the product detail content 330 shown in FIG. 3 include both graphical and textual content, this is not a requirement of the present invention. Rather, such regions may include any kind of content. For example, the additional content region 314 may simply include text that acts as a trigger to display the product detail content 330. As yet another example, the additional content region 313 may include a button or other user interface element that acts as a trigger to display the product detail content 330.

Graphic elements of the particular embodiment illustrated in FIG. 3 have the following dimensions, which are provided merely for purposes of example and do not constitute limitations of the present invention. The product detail content 330 is 304 pixels tall by 370 pixels wide. The mini-scrollbar therefore only appears when the content in the content 330 is greater than 304 pixels tall. Furthermore, a horizontal mini-scrollbar may be displayed if the content in the content 330 is greater than 370 pixels wide.

The scrollbar 304 is 20 pixels wide, plus 15 pixels of white space on each side (for a total of 50 pixels for the scrollbar 304 plus the surrounding whitespace. The panes 302a-b and scrollbar 304, therefore, combine to 790 pixels wide. Each of the elements 308a-k is 98 pixels tall, with an additional 5-pixel tall horizontal gray line separating the rows of elements 308a-k from each other. The inner circle 320 has a 30-pixel diameter, while the outer circle 322a has a 53-pixel diameter. The mini-scrollbar 334 is 15 pixels wide and 60 pixels tall. The ring 322b around the circle 322b in the mini-scrollbar region is 3 pixels wide.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Network communications may be performed over any kind of physical and/or logical connection(s) among any kind and number of computers. For example, network communications may be performed over the public Internet or private internet or intranet, or over a direct (e.g., parallel or serial) connection among computers.

1. A computer-implemented method comprising:
(A) displaying a rendering of content, the rendering including a first pane including a rendering of first pane content and a second pane including a rendering of second pane content;
(B) displaying a first movement-control element;
(C) receiving input from a user directed to the first movement-control element; and
(D) moving the rendering of the first pane content and the rendering of the second pane content in response to the input.

2. The method of claim 1, wherein the content comprises a web page, and wherein displaying the rendering of the content comprises displaying the rendering of the content in a web browser window.

3. The method of claim 2, wherein the first pane comprises a first frame in the web browser window, and wherein the second pane comprises a second frame in the web browser window.

4. The method of claim 1, wherein the first movement-control element comprises a slider bar.

5. The method of claim 1, further comprising:
(E) moving the first movement-control element in response to the input.

6. The method of claim 5, wherein (D) comprises moving the renderings of the first and second pane contents in a first direction, and wherein (E) comprises moving the first movement-control element in a second direction substantially opposite to the first direction.

7. The method of claim 5, wherein (A) comprises displaying the first pane and second pane on opposing sides of the first movement-control element, and wherein (E) comprises moving the first movement control element within a gap between the first and second panes.

8. The method of claim 7, wherein (A) comprises displaying links to additional content within the first pane and second pane near the first movement-control element.

9. The method of claim 5, wherein each of the first and second panes is substantially rectangular, and wherein the dimensions of the first pane are substantially the same as the dimensions of the second pane.

10. The method of claim 5, wherein the first and second panes are not adjacent to each other.

11. The method of claim 1, further comprising:
(C) displaying a rendering of first linking content within the first pane and substantially adjacent to the first movement-control element, wherein the first linking content links to first linked-to content.

12. The method of claim 11, further comprising:
(D) displaying a rendering of second linking content within the second pane and substantially adjacent to the first movement-control element, wherein the second linking content links to second linked-to content.

13. The method of claim 11, further comprising:
(F) receiving input from the user selecting the first linking content; and
(G) in response to the input received in (F), displaying a rendering of the first linked-to content over the first pane.

14. The method of claim 13, wherein (F) comprises receiving an indication of a mouseover event having the first linking content as its object.

15. The method of claim 13, wherein the rendering of the first linking content and the rendering of the second linking content are of equal size.

16. The method of claim 13, wherein the rendering of the first linked-to content has an area that is an integer multiple of the area of the rendering of the first linking content.

17. The method of claim 13, further comprising:
(H) displaying a rendering of third linking content within the rendering of the first linked-to content, wherein the third linking content links to third linked-to content.

18. The method of claim 13, further comprising:
(H) in response to the input received in (F), changing a visual feature of the rendering of the first linking content to indicate that the user has selected the first linking content.

19. The method of claim 18, wherein (F) comprises receiving an indication of a mouseover event having the first linking content as its object.

20. The method of claim 11, further comprising:
(F) displaying a second movement-control element within the first pane, wherein the second movement-control element is responsive to user input to move the rendering of the first linking content.

21. The method of claim 1, wherein the first movement-control element is adjacent to the first pane and the second pane.

22. An apparatus comprising:
content display means for displaying a rendering of content, the rendering including a first pane including a rendering of first pane content and a second pane including a rendering of second pane content;
control display means for displaying a first movement-control element;
input means for receiving input from a user directed to the first movement-control element; and
movement means for moving the rendering of the first pane content and the rendering of the second pane content in response to the input.

23. A computer-implemented method comprising:
(A) displaying a rendering of a web page, the rendering including a first frame including a rendering of first frame content and a second frame including a rendering of second frame content, wherein each of the first and second frames is substantially rectangular, and wherein the first frame has dimensions that are substantially the same as dimensions of the second frame;
(B) displaying a slider bar between and adjacent to the first and second frames;
(C) receiving input from a user directed to the slider bar; and
(D) moving the rendering of the first frame content and the rendering of the second frame content in response to the input.

24. The method of claim 23, further comprising:
(E) displaying a rendering of first linking content within the first frame and substantially adjacent to the slider bar, wherein the first linking content links to first linked-to content;
(F) receiving input from the user selecting the first linking content, the input comprising an indication of a mouseover event having the first linking content as its object; and
(G) in response to the input received in (F), displaying a rendering of the first linked-to content over the first frame.

25. (canceled)

26. An apparatus comprising:
content display means for displaying a rendering of a web page, the rendering including a first frame including a rendering of first frame content and a second frame including a rendering of second frame content, wherein each of the first and second frames is substantially rectangular, and wherein the first frame has dimensions that are substantially the same as dimensions of the second frame;
control means for displaying a slider bar between and adjacent to the first and second frames;
input means for receiving input from a user directed to the slider bar; and
movement means for moving the rendering of the first frame content and the rendering of the second frame content in response to the input.
